(19) United States
(12) Patent Application Publication
(10) Pub. No.: US 2024/0278356 A1
(43) Pub. Date: Aug. 22, 2024

(54) PAINT REMOVAL BOOTH ASSEMBLY INCLUDING AT LEAST ONE LASER ABLATION ROBOT

(71) Applicant: Gallagher-Kaiser Corporation, Troy, MI (US)

(72) Inventors: Adam RUSEK, Highland, MI (US); David JACKSON, Hazel Park, MI (US); Johnathan GILBERT, Flint, MI (US); Christopher FREITAS, Fenton, MI (US)

(21) Appl. No.: 18/443,369

(22) Filed: Feb. 16, 2024

Related U.S. Application Data
(60) Provisional application No. 63/446,609, filed on Feb. 17, 2023.

(51) Int. Cl. B23K 26/402; B23K 26/08; B23K 26/142; B23K 26/352; B23K 37/04

(52) U.S. Cl. CPC B23K 26/402; B23K 26/0884; B23K 26/142; B23K 26/352; B23K 37/04

(57) ABSTRACT

A paint removal booth assembly includes a paint removal booth that defines an interior and includes an entry door for allowing a skid having built-up paint overspray to enter the interior. A platform is disposed within the interior of the paint removal booth adjacent to the entry door for receiving the skid. At least one laser ablation device is disposed in the interior of the paint removal booth and configured to generate and direct a laser beam towards the skid for ablating the built-up paint overspray from the skid and generating ablated paint particles in the interior of the paint removal booth. A debris capturing assembly is disposed in fluid communication with interior of the paint removal booth for drawing the ablated paint particles from the interior of the paint removal booth and directing them to a collection drum disposed in an environment outside of the paint removal booth.

### CROSS-REFERENCE TO RELATED APPLICATION

This application claims the benefit of U.S. Provisional Patent Application Ser. No. 63/446,609 filed on Feb. 17, 2023, the entire disclosure of which is incorporated herein by reference.

### BACKGROUND OF THE INVENTION

### 1. Field of the Invention

The present disclosure generally relates to a paint removal booth assembly, and more specifically to a paint removal booth assembly for removing built-up paint overspray from skids used in a manufacturing paint shop.

### 2. Related Art

The section provides a general summary of background information and the comments and examples provided in this section are not necessarily prior art to the present disclosure.

Paint booths are used in many industrial applications for applying paint to components or assemblies (e.g., vehicle bodies, doors, panels, or the like) that are conveyed through the manufacturing paint shop on skids. During the painting process, the skids are exposed to and accumulate paint overspray, which is not otherwise applied to the respective components and builds up over time on the skid. This build-up of paint overspray can prevent the skids from functioning properly or prevent the components or assemblies from being properly coated with the paint, such as insulating the components from the skid and preventing a proper electrical ground during the painting process. Accordingly, paint removal booths are used in paint shops to periodically remove this paint overspray build-up from the skids. However, current paint removal booths rely on inefficient and unsafe methods for achieving this paint removal from the skids.

More specifically, current paint removal booth assemblies predominantly rely on high-pressure water tools (e.g., power washing equipment) for removing paint overspray. In some cases, the high-pressure water tools are even manually operated, which creates a hazard to operators of the power washing equipment. The use of high-pressure water tools also requires an extensive amount of water to remove the paint overspray, which necessarily forms a slurry of paint particles and wastewater which must be treated and/or properly disposed during and after the paint removal process. But, such wastewater treatment requires significant electrical and water usage. For example, a current paint removal booth sized for an automotive paint shop requires an estimated annual electrical usage of 3,700,000 kW and water usage of 8,760,000 US gallons, and associated annual costs of $230,000.

Accordingly, there remains a continuing need for improved paint removal booth assemblies which are more efficient, safer for operation, and provide an improved and less costly paint removal process.

### SUMMARY OF THE INVENTION

This section provides a general summary of the disclosure and is not intended to be a comprehensive disclosure of its full scope, aspects, objectives, and/or all of its features.

The subject disclosure is generally related to a paint removal booth assembly configured to remove paint overspray build-up from a skid and collect the removed paint particles in a solid form for easier and more efficient disposal relative to prior art wastewater treatment methods. In a preferred arrangement, the paint removal booth assembly includes a paint removal booth defining an interior and including an entry door for allowing a skid having built-up paint overspray to enter the interior. A platform is disposed within the interior of the paint removal booth adjacent to the entry door for receiving the skid. At least one laser ablation device is disposed in the interior of the paint removal booth and configured to generate and direct a laser beam towards the skid for ablating the built-up paint overspray from the skid and generating ablated paint particles in the interior of the paint removal booth. A debris capturing assembly is disposed in fluid communication with the interior of the paint removal booth and is configured to draw the ablated paint particles from the interior of the paint removal booth and direct them to a collection drum disposed in an environment outside of the paint removal booth.

The paint removal booth assembly in accordance with the subject disclosure removes and collects paint without an extensive amount of water, labor, or other costs associated with the less efficient paint removal booth assemblies described in the background section above. For example, a paint removal system based on the laser ablation device and comparatively sized to the prior art high-pressure water removal methods discussed in the background section above requires approximately 85% less electrical usage and 0 gallons of water each year resulting in annual savings of approximately $200,000 dollars. The collection of the ablated paint particles in solid form also allows for simpler transportation and disposal of the built-up paint overspray by an operator since they are collected in the collection drum which is easily removed and replaced by the operator. In other words, use of a collection drum allows for simpler collection and easy disposal of the ablated paint particles. Further areas of applicability will become apparent from the description provided herein.

### BRIEF DESCRIPTION OF THE DRAWINGS

Other aspects of the present disclosure will be readily appreciated, as the same becomes better understood by reference to the following detailed description when considered in connection with the accompanying drawings wherein:

FIG. 1 is a perspective side view of a paint removal booth assembly which includes a paint removal booth and a debris capturing assembly disposed in communication with an interior of the paint removal booth;

FIG. 2 is a perspective front view of the paint removal booth assembly illustrating an entry door defined by a front wall of the paint removal booth and a platform disposed within the interior of the paint removal booth and adjacent to the entry door for receiving a skid having built-up paint overspray from a conveyor disposed in an environment of the paint removal booth;

FIG. 3 is a perspective side view of the paint removal booth assembly taken from an opposite side to that shown in FIG. 1 to illustrate a control system for the paint removal booth assembly;

FIG. 4 is a perspective rear view of the paint removal booth assembly illustrating a main body, a hopper and a collection drum of the debris capturing system sequentially arranged one another for directing the ablated paint particles into the collection drum;

FIG. 5 is a cross sectional side view of the paint removal booth assembly illustrating at least one laser ablation robot having at least one laser ablation device disposed in the interior of the paint removal booth and adjacent to the platform, and a collection duct extending beneath the platform and disposed in fluid communication with the debris capturing system;

FIG. 6 is a cross sectional front view of the paint removal booth assembly illustrating the at least one laser ablation device configured to generate and direct a laser beam towards the ski for ablating the built-up paint overspray from the ski and generating ablated paint particles in the interior of the paint removal booth;

FIG. 7 is a magnified view of a portion of the cross sectional side view of FIG. 5 to more clearly illustrate the ablated paint particles entering the collection duct through a plurality of particle inlets defined by a pair of side duct surfaces of the collection duct;

FIG. 8 is a magnified view of a portion of FIG. 7 to more clearly illustrate the collection duct for capturing and conveying the ablated paint particles from the interior of the paint removal booth to the debris capturing assembly; and

FIG. 9 is a flowchart of a method for removing paint build-up from a skid.

### DETAILED DESCRIPTION OF THE ENABLING EMBODIMENTS

Example embodiments will now be described more fully with reference to the accompanying drawings. The example embodiments are provided so that this disclosure will be thorough and fully convey the scope to those skilled in the art. In some example embodiments, well-known processes, well-known device structures, and well-known technologies are not described in detail. Numerous specific details are set forth such as examples of specific components, devices, mechanisms, assemblies, and methods to provide a thorough understanding of various embodiments of the present disclosure. It will be apparent to those skilled in the art that specific details need not be employed, that example embodiments may be embodied in many different forms, and that neither should be construed to limit the scope of the disclosure. With this in mind, the present disclosure is generally directed to an improved paint removal booth assembly and an improved paint removal process.

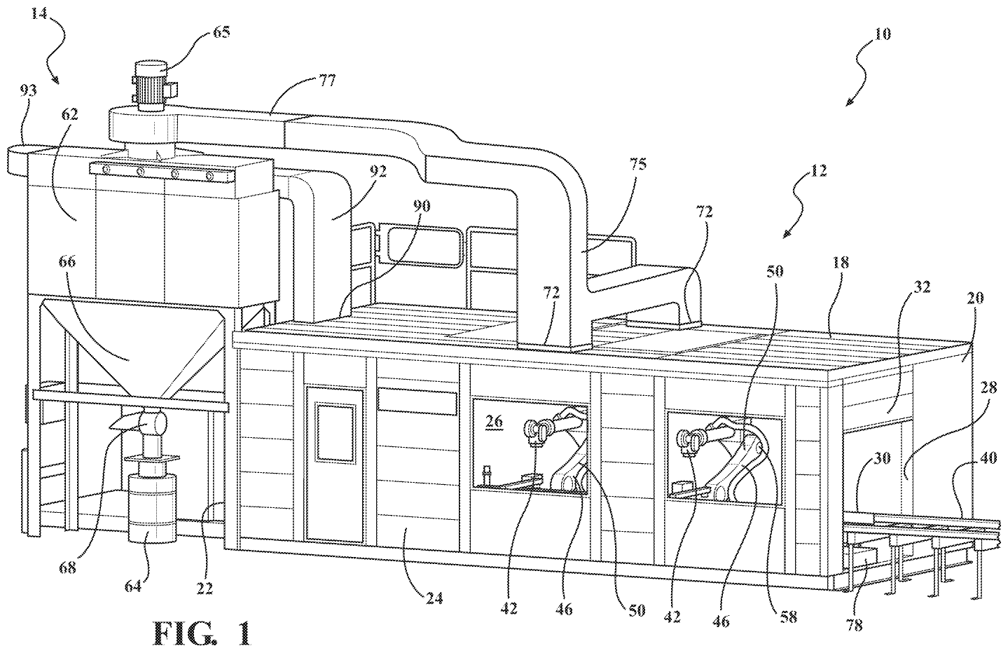

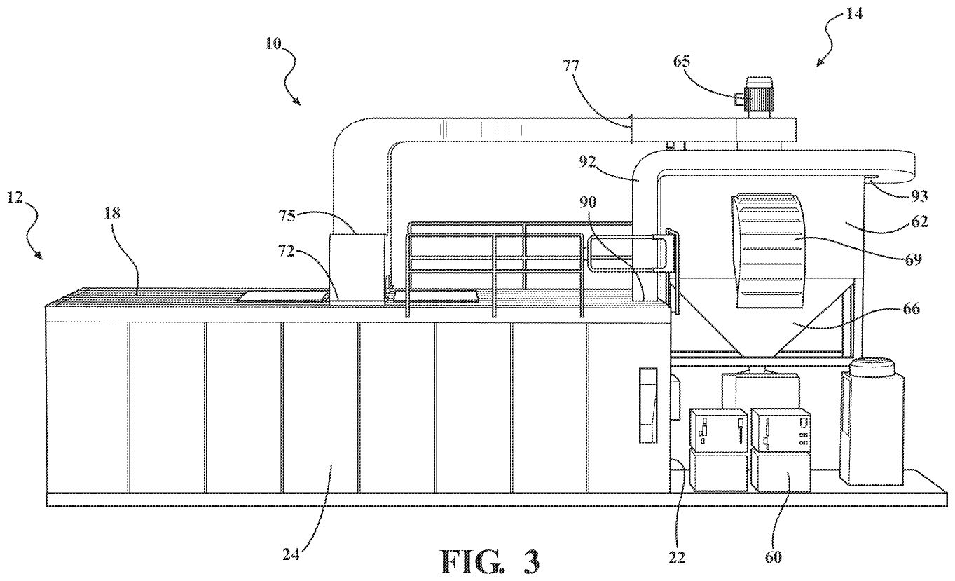

As best illustrated in FIGS. 1-5, wherein like numerals indicate corresponding parts throughout the several views, a paint removal booth assembly 10 includes a paint removal booth 12 and a debris capturing assembly 14 disposed adjacent to the paint removal booth 12. The paint removal booth 12 is generally rectangular in shape and includes a floor 16, a ceiling 18, a front wall 20, a rear wall 22 opposite the front wall 20, and a pair of side walls 24 extending between the front wall 20 and the rear wall 22, all of which collectively define an interior 26.

One of the front wall 20, the rear wall 22, or the side walls 24 defines an entry door 28 through which a skid 30 having paint overspray build-up and thus designated for cleaning is allowed to enter the interior 26 of the paint removal booth 12. In the preferred arrangement, the front wall 20 defines the entry door 28, and a retractable door 32 is preferably attached to the entry door 28 and is translatable between an open position (as shown in FIGS. 1, 2, and 5) for allowing the skid 30 to pass through the entry door 28 and a closed position (not expressly shown) for enclosing the skid 30 within the interior 26 of the paint removal booth 12 in preparation for a paint removal process.

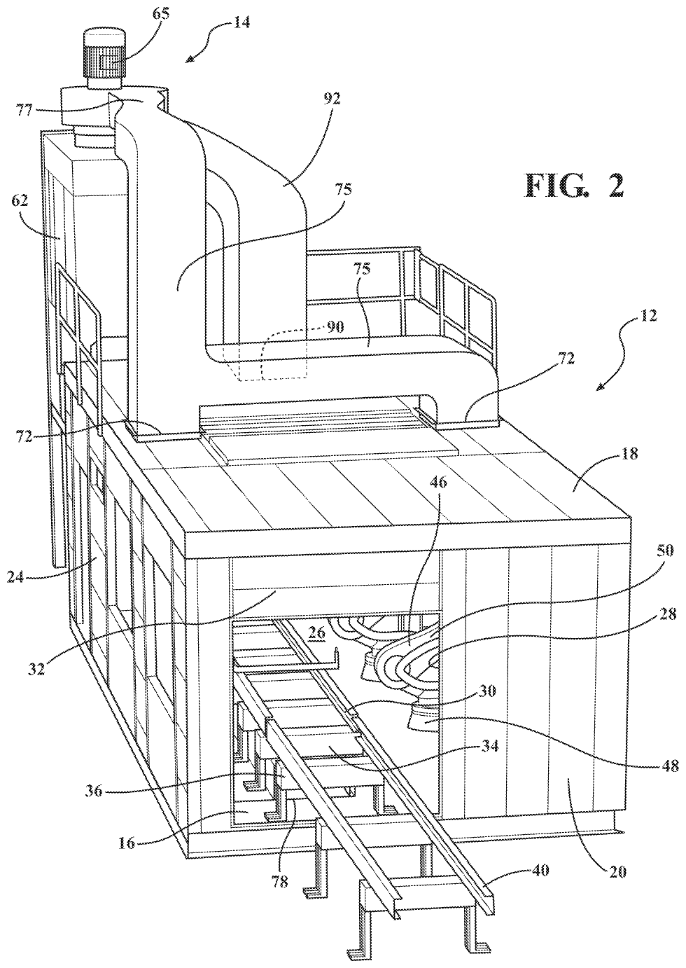

As best illustrated in FIGS. 2 and 5-8, a platform 34 is disposed within the interior 26 in a raised or elevated relationship relative to the floor 16 and in adjacent and aligned relationship with the entry door 28 for receiving the skid 30 after it is has passed through the entry door 28. In a preferred embodiment, the platform 34 includes a plurality of cross-members 36 extending transversely relative to the side walls 24 in spaced relationship with one another, and each including at least one roller 38 for allowing the skid 30 to pass along consecutive plurality of cross-members 36 as it enters through the entry door 28 and is conveyed through the interior 26.

In an embodiment, a fork lift can be utilized to pass the skid 30 through the entry door 28 and onto the platform 34. However, as best illustrated in FIGS. 1-2, in a preferred arrangement the platform 34 is disposed in communication with and in-line with a conveyor 40 of the manufacturing paint shop, such that the skid 30 designated for cleaning and paint removal can be automatically routed along the conveyor 40, towards the paint removal booth 12, through the entry door 28 and onto the platform 34. As will be appreciated in view of the following more detailed disclosure, once the skid 30 is cleaned in the paint removal booth 12, the platform 34 can then route the cleaned skid 30 out of the paint removal booth 12 (such as back out of the entry door 28, or through an exit door defined by one of the other walls) for replacement by another skid for cleaning, either manually via the fork lift or automatically routed by the conveyor 40.

As best illustrated in FIGS. 1 and 5-8, the paint removal booth assembly includes at least one laser ablation device 42 disposed in the interior 26 of the paint removal booth 12 and configured to generate and direct a laser beam 44 towards the skid 30 for ablating the paint build-up from the skid 30 and generating ablated (and solid) paint particles 45 in the interior 26 of the paint removal booth 12. Put another way, the laser beam 44 generated by the at least one laser ablation device 42 is directed towards the skid 30 to heat the surface and ablate the built-up paint from the skid 30 without causing damage to the surface of the skid 30. The laser beam 44 may be a pulsed laser beam with variable power to clean the surfaces of the skid 30, where the power may be on a range of 10 Watts (W) to 100 W, 100 W to 500 W, or 500 W to 3000 W, or the like, where an increase in power allows for larger areas to be cleaned at a time, faster movement of the laser beam 44, or both. The pulsed laser beam 44 may use millisecond, picosecond, nanosecond, or femtosecond pulses. For example, the duration of the pulses of the pulsed laser beam 44 may between 10 to 1600 nanoseconds. The at least one laser ablation device 42 may also use a continuous wave laser beam 44 where the power may be on a range of 10 Watts (W) to 100 W, 100 W to 500 W, or 500 W to 3000 W, or 3000 W to 5000 W, or the like. The at least one laser ablation device 42 may include single mode lasers, multimode lasers, or both. The wavelength of the laser beam 44 may be adjusted depending on the thickness of the paint overspray built-up on the skid. For example, the laser beam 44 can have a wavelength of 1060 nm, 10600 nm, or the like. It is contemplated that the wavelength, power, and/or pulse duration can be adjusted to remove paint at a desired depth without damaging the surface of the skid 30. In embodiments using a pulsed laser beam 44, the wavelength, power, and/or pulse duration may be adjusted between or after a certain number of pulses to either increase or decrease the depth at which paint is removed from the skid 30. For example, the depth of the laser beam 44 may be at least 10 mm. In other embodiments, the depth of the laser beam 44 may be at least 20 mm, 50 mm, 100 mm, 150 mm, or the like.

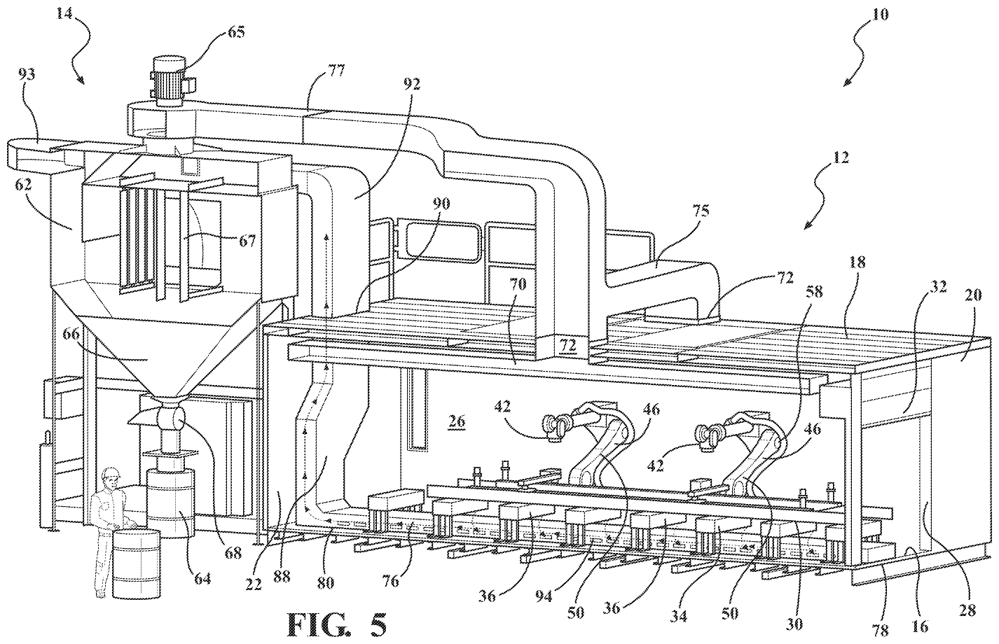

As best illustrated in FIGS. 5-8, the paint removal booth 12 includes at least one laser ablation robot 46 disposed within the interior 26 adjacent, and preferably along a side of or above, the platform 34. For example, in the preferred arrangement, the at least one laser ablation robot 46 is mounted to the floor 16. However, the at least one laser ablation robot 46 can be mounted to the ceiling 18, or side walls 24, without departing from the scope of the subject disclosure. The at least one laser ablation robot 46 includes a base 48, and an arm 50 connected to the base 48 and extending from a first arm end 52 to a second arm end 54. The base 48 and/or the arm 50 are preferably configured to rotate such that the position, direction, and orientation of the arm 50 can be adjusted relative to the platform 34. The arm 50 is also preferably an articulating arm with at least one joint 58. The at least one joint 58 is configured to be pivotable such that segments of the arm 50 separated by the at least one joint 58 can pivot about the at least one joint 58 in one or more directions relative to the at least one joint 58. The at least one joint 58 can also be configured to rotate in one or more directions about the at least one joint 58.

The at least one laser ablation device 42 is connected to the at least one laser ablation robot 46, preferably connected or mounted to the second arm end 54. The at least one laser ablation device 42 can be configured to rotate and/or pivot in one or more directions about the second arm end 54. The position and/or orientation of the at least one laser device 42 can be adjusted by articulation or rotation of the arm 50 and/or the at least one laser ablation device 42 to direct the laser beam 44 generated by the at least one laser device 42 towards the skid 30.

In a preferred embodiment, the paint removal booth 12 includes a plurality of laser ablation devices 42 for removing paint built-up from the skid 30. The plurality of the laser ablation devices 42 are configured to each generate a respective laser beam 44, in accordance with the aforementioned characteristics. The paint removal booth 12 further includes a plurality of laser ablation robots 46 disposed in a spaced relationship with one another adjacent the platform 34. The plurality of the laser ablation devices 42 are each connected to a respective one of the plurality of the laser ablation robots 46. In this way, the plurality of laser ablation devices 42 can each direct a plurality of laser beams 44 towards the skid contemporaneously from varying positions, orientations, modes, or the like. As best illustrated in FIGS. 5-8, in a preferred arrangement, the plurality of laser ablation robots 46 are disposed on the same side of the platform 34. However, the plurality of laser ablation robots 46 could be disposed on both sides of the platform 34 without departing from the subject disclosure.

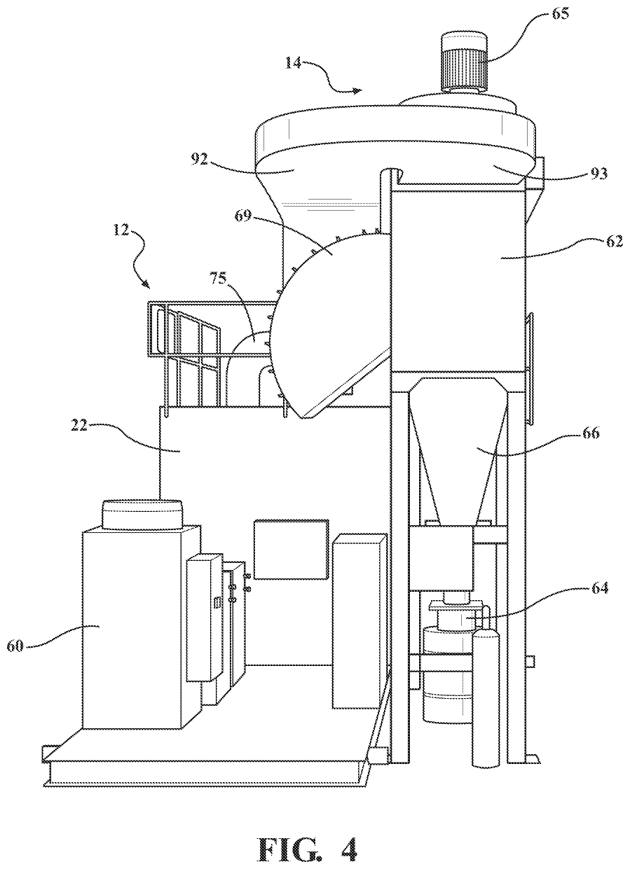

A control system 60 is disposed in communication with the at least one laser ablation robot 46 for establishing automatic control of the at least one laser ablation robot 46. The control system 60 may be positioned in the interior 26 of the paint removal booth 12 or disposed outside of an environment of the paint removal booth 12, such as secured to one of the front or rear walls 20, 22 or side walls 24, or positioned as a separate standalone unit (as illustrated in FIG. 4). The control system 60 is communicatively coupled to the at least one laser ablation robot 46 for sending control signals to at least one laser ablation robot 46 and/or the laser ablation device 42, and to controlling the positioning of the skid 30 on the platform 34 via the at least one roller 38. Additionally, the control system 60 may be configured to control the routing of the skid 30 from the manufacturing shop along the conveyor 40 to and from the paint removal booth 12. For example, the control system 60 can open and close the retractable door 32, direct the skid 30 designated for cleaning to be transported from the conveyor 40 to the platform 34, and direct the skid 30 after it has been cleaned to be transported from the platform 34 to the conveyor 40.

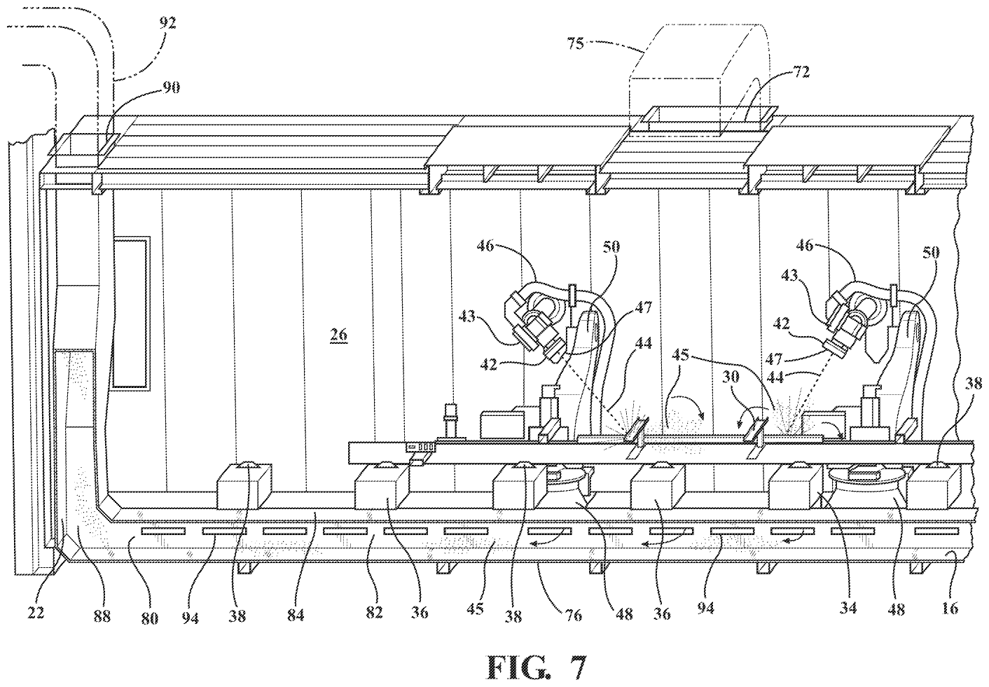

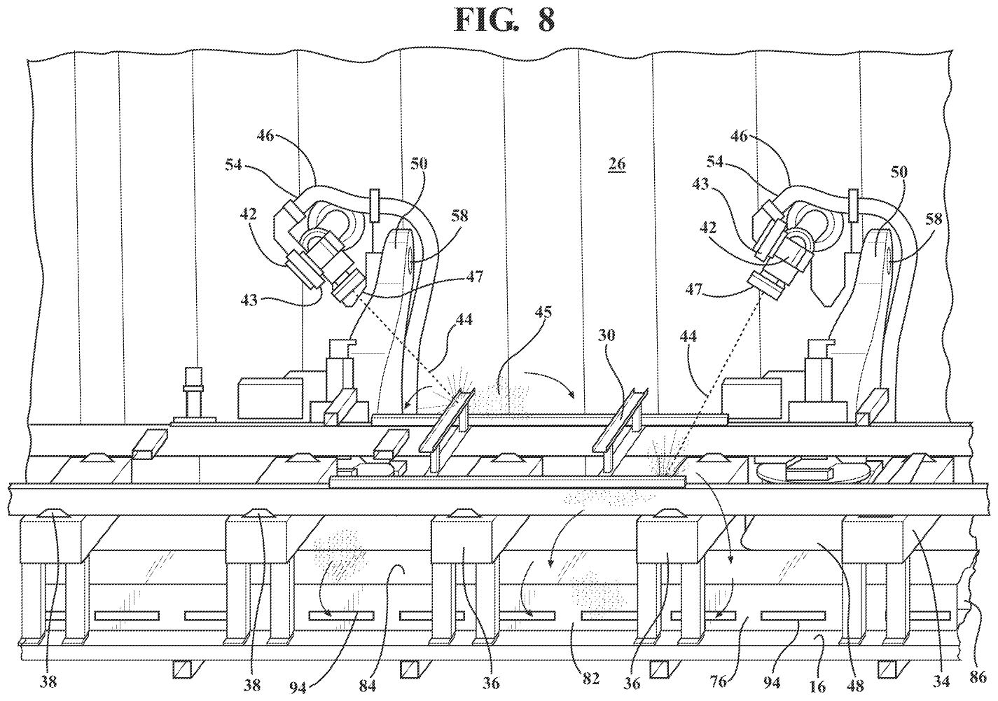

As best illustrated in FIGS. 7-8, the at least one laser ablation device 42 includes an optical element 47 for directing and focusing the laser beam 44 of the at least one laser ablation device 42 to a desired location on the surface of the skid 30. The optical element 47 can also be configured to modify the diameter, width, length, or the like, of the laser 44 beam such that the laser beam 44 can be adjusted to match a profile of the surface of the skid 30, decrease the time of the process, focus on a particularly thick layer of paint, or the like. For example, the laser beam 44 can be adjusted based on the surface of individual portions of the skid 30 as the laser beam 44 is removing the paint. The laser beam 44 can also be adjusted based on the location of the at least one laser ablation device 42 relative to the surface of the skid 30 (e.g., the angle of the laser beam 44 based on the position or orientation of the at least one laser ablation device 42 relative to the skid 30). In another example, the area of the surface of the skid 30 can be increased or decreased to adjust the time required to remove paint from the surface of the skid 30 (e.g., increasing the area of the laser beam 44 would remove a greater amount of paint from the surface of the skid 30 and require less time for the overall process, whereas decreasing the area of the laser beam 44 could allow for greater control of the removal process).

In certain embodiments, and as also shown in FIGS. 7-8, the at least one laser ablation device 42 includes at least one sensor 43 for detecting paint on the skid 30. The at least one sensor 43 may also be configured to determine a thickness of the paint at a particular location on the surface of the skid 30 such that the parameters of the laser beam 44 from the at least one laser ablation device 42 are adjusted to remove the paint without causing damage to the surface of the skid 30. The at least one sensor 43 may also be configured to determine a distance from the at least one laser ablation device 42 to the surface of the skid 30 and communicate the distance to the laser ablation device 42. Based on the distance the at least one laser ablation device 42 may stop firing the laser beam 44. For example, the distance between the at least one laser ablation device 42 and the surface of the skid 30 may outside of a pre-defined working distance such that the at least one laser ablation device 42 temporarily stop generating the laser beam 44 and adjust the position of the at least one laser ablation device 42 to be within the pre-defined working distance. The at least one sensor 43 may include a laser, camera, or any other type of sensor suitable for the aforementioned purposes. The control system 60 may also be communicatively coupled to the optical element 47 and/or at least one sensor 43.

In a preferred embodiment, the debris capturing assembly 14 is disposed in fluid communication with the interior 26 of the paint removal booth 12 and is configured to draw the ablated paint particles 45 from the interior 26 of the paint removal booth 12 and direct them to a collection drum 64 disposed in an environment outside of the paint removal booth 12. As mentioned previously, use of the collection drum 64 allows for an operator to easily dispose of the ablated paint particles 45 by simply removing and replacing the collection drum 64, and transporting the full collection drum 64 via a fork lift, or the like to a designated location for emptying and disposal. The debris capturing assembly 14 includes a motor 65 for generating a vacuum to draw air from the interior 26 of the paint removal booth 12 and into a main body 62 of the debris capturing assembly 14. The main body 62 filters debris or the ablated paint particles 45 from the air from the interior 26 of the paint removal booth 12 and passes the ablated paint particles 45 to the collection drum 64 disposed outside of the debris capturing assembly 14. The collection drum 64 being disposed outside of the debris capturing assembly 14 (and the paint removal booth 12) allows for an operator to easily change, move, inspect, or adjust the collection drum 64. In particular, the collection drum 64 contains solid waste (i.e., the ablated paint particles 45) and can be transported and stored much easier than a storage and treatment system for wastewater. The collection drum 64 is large enough to contain the ablated paint particles 45 removed from the skid 30. In certain embodiments, and as best shown in FIG. 5, during operation a first collection drum 64 that becomes full can be exchanged with a second collection drum 64 without stopping the laser ablation process or the conveyance of ablated paint particles 45 to the debris capturing assembly 14.

As best shown in FIG. 5, in certain embodiments, the main body 62 includes a plurality of filters 67, a baghouse, or the like. For example, where the debris capturing assembly 14 is a baghouse dust collector, the plurality of filters 67 are bag filters. As the contaminated air from the interior 26 of the paint removal booth 12 enters the main body 62, solid particulates fall into a hopper 66 and then are collected in the collection drum 64 simply via gravity or passing through a rotary air lock system 68, and/or are collected on the outside of the plurality of filters 67. When the ablated paint particles 45 are collected on the plurality of filters 67, the ablated paint particles 45 can be removed by mechanical shaking, reverse air flow, pulse jets, sonic cleaning, or the like, whereby the ablated paint particles 45 are then collected in the collection drum 64. Alternatively, the plurality of filter bags may be removed from the main body 62 and either be cleaned using other methods and/or safely disposed of. The plurality of filters 67 are composed of a filter media suitable for filtering the ablated paint particles 45 and other hazardous materials from the air. For example, plurality of filters 67 may include woven or nonwoven fabrics or filters. In other embodiments, the main body 62 may further include an integrated airhouse section disposed downstream of the dry scrubber section that may include additional filters, cooling coils, and/or fans to be subsequently released either into the environment or introduced back into the paint removal booth 12 for subsequent use as downdraft air. In some embodiments, the debris capturing assembly 14 includes a flame vent 69 for relieving a potential explosion within the debris capturing assembly 14 without causing damage to the debris capturing assembly 14. An explosion could occur in the event that the ablated paint particles 45 and/or other debris produce a combustible mixture that is ignited.

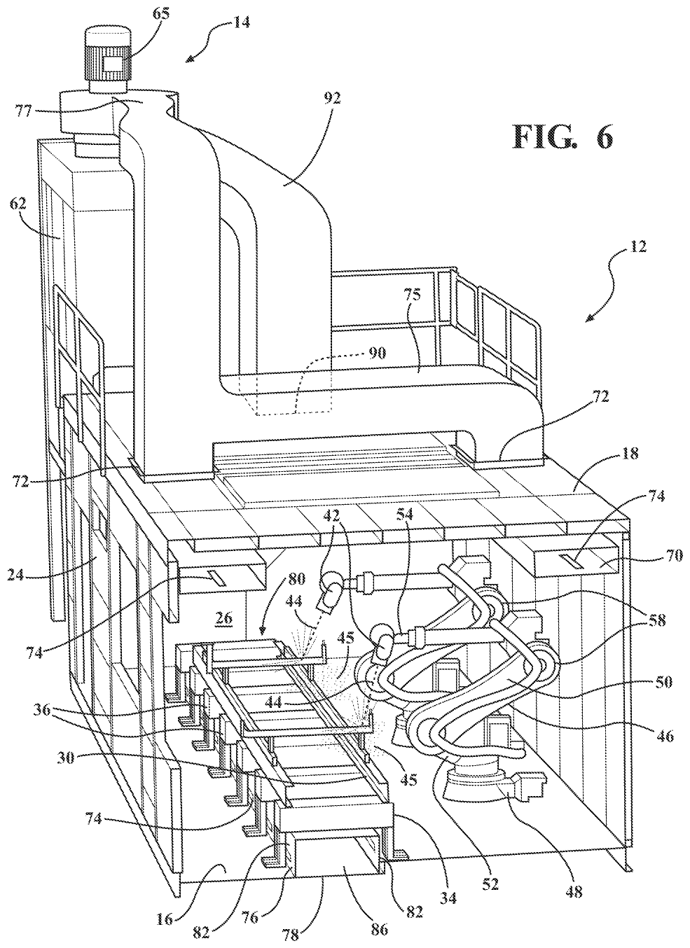

To filter and collect the ablated paint particles 45 a vacuum system is created by introducing air into the paint removal booth 12 and drawing air into the debris capturing assembly 14 via the motor 65 generating the vacuum. The paint removal booth 12 includes an intake duct 70 in fluid communication with an intake port 72 and outlet port 74 such that the intake duct 70 is configured to draw air from outside of the paint removal booth 12 via the intake port 72 and direct air into the interior 26 of the paint removal booth 12 via the outlet port 74. An intake fan or blower may be connected to the intake duct 70 for introducing air into the interior 26 of the paint removal booth 12. The intake duct 70 may be housed within the paint removal booth 12 and the intake port 72 may be connected to the ceiling 18, the front wall 20, the rear wall 22, or one of the side walls 24. As best illustrated in FIGS. 5 and 6, the paint removal booth 12 may include a plurality of intake ducts 70 each with an individual intake port 72 an outlet port 74. Preferably, the intake duct 70 or the plurality of intake ducts 70 are disposed adjacent to the side walls 24 and spaced apart from the platform 34 to create an airflow that flows from the side walls 24 towards the platform 34. In certain embodiments, the intake duct 70 may include a plurality of intake ports 72 and/or a plurality of outlet ports 74, in which the plurality of outlet ports 74 are positioned to adjust the airflow into the interior 26 of the paint removal booth 12. For example, the plurality of outlet ports 74 are disposed uniformly along the length of the intake duct 70 such that the airflow into the interior 26 of the paint removal booth 12 is uniform across the length of the side wall 24. In another example, the plurality of the outlet ports 74 are disposed non-uniformly such that the airflow into the interior 26 of the paint removal booth 12 is non-uniform (e.g., a non-uniform airflow can be used to have a greater airflow at certain segments of the side wall 24 to direct the overall airflow in the interior 26 of the paint removal booth 12 towards a desired direction).

In an embodiment, a supply duct 75 extends from a filter outlet 77 of the debris capturing assembly 14 to the intake port 72 for establishing fluid communication therebetween. In other words, air from the interior 26 of the paint removal booth 12 is drawn into the debris capturing assembly 14 and/or main body 62, filtered, and returned to the interior 26 of the paint removal booth 12.

The paint removal booth 12 includes a collection duct 76 extending beneath the platform 34 and disposed in fluid communication with the debris capturing assembly 14 for capturing and conveying the ablated paint particles 45 from the interior 26 of the paint removal booth 12 to the debris capturing assembly 14. The collection duct 76 extends along the floor 16 from a first duct end 78 disposed adjacent the front wall 20 to a second duct end 80 disposed adjacent the rear wall 22 to define a pair of side duct surfaces 82 extending in spaced and generally parallel relationship with one another and connected by an upper duct surface 84 facing the platform 34. The pair of side duct surfaces 82 and the upper duct surface 84 define an inner chamber 86 of the collection duct 76.

A chute 88 is disposed in communication with the second duct end 80 and extends upwardly along the rear wall 22 to an exhaust port 90 defined by the ceiling 18. A coupling duct 92 extends from the exhaust port 90 to a debris inlet 93 of the debris capturing assembly 14 for establishing fluid communication therebetween. The debris inlet 95 is disposed in fluid communication with the main body 62 and can be disposed on a side surface of the main body 62. It is contemplated that the chute 88 may be disposed outside of the paint removal booth 12 and the exhaust port 90 may be disposed on a different panel or wall of the paint removal booth 12 other than on the ceiling 18 without departing from the scope of the subject disclosure. The chute 88 can also be a continuation of the dimensions of the collection duct 76 or have a different shape or size more suitable for the vertical conveyance of the ablated paint particles 45 to the debris capturing assembly 14. Similarly, the exhaust port 90 may be designed for suitable fluid communication with the coupling duct 92 and conveyance of ablated paint particles 45 to the debris capturing assembly 14. For example, the exhaust port 90 may be sealed to the coupling duct 92 to prevent pressure loss, and the coupling can have a bend or angle to convey the ablated paint particles 45 to the debris capturing assembly 14 without resulting in significant turbulence, or the like.

In a preferred arrangement, the pair of side duct surfaces 82 each define a plurality of particle inlets 94 disposed in spaced relationship with one another for receiving and allowing ablated paint particles 45 to enter the inner chamber 86 of the collection duct 76 and be conveyed to the debris capturing assembly 14. Placement of the plurality of particle inlets 94 by the pair of side duct surfaces 82 disposes the plurality of particle inlets 94 adjacent the floor 16 and in a position that prevents blockage of the plurality of particle inlets 94. However, the plurality of particle inlets 94 could also be placed alternatively or additionally on the upper duct surface 84 without departing from the scope of the subject disclosure.

The intake duct 70 and the collection duct 76 are configured to create an overall airflow in the interior 26 of the paint removal booth 12 such that the ablated paint particles 45 are directed towards the plurality of particle inlets 94 and drawn into the collection duct 76. For example, the intake duct 70 draws air from outside of the paint removal booth 12 through the intake port 72 and directs the air through the outlet port 74 towards the platform 34 (e.g., downwards from the ceiling 18 and away from the side walls 24). This airflow directs the ablated paint particles 45 in the interior 26 of the paint removal booth 12 towards the collection duct 76. As shown in FIGS. 5, 7 and 8, the vacuum generated by the motor 65 then draws the ablated paint particles 45 through the plurality of particle inlets 94 and into the inner chamber 86 of the collection duct 76. The ablated paint particles 45 captured in the inner chamber 86 are conveyed to the chute 88 and exit the paint removal booth 12 through the exhaust port 90, where the ablated paint particles 45 are then conveyed to the main body 62 of the debris capturing assembly 14 by the coupling duct 92. Upon entering the main body 62 the ablated paint particles 45 are collected in the collection drum 64, and/or are collected in the collection drum 64 after being removed from the plurality of filters 67. In this way, the overall airflow from the outlet port 74 to the plurality of particle inlets 94 allows the ablated paint particles 45 to be captured and removed from the interior 26 of the paint removal booth 12, rather than remaining airborne or accumulating on various surfaces in the interior 26 of the paint removal booth 12. As previously mentioned, it is contemplated that the airflow of the vacuum system can be controlled by adjusting the various components of the paint removal booth assembly 10, such as the intake duct 70, the collection duct 76, the power of the motor 65, the distance between the exhaust port 90 and the main body 62, or the like, or a combination or sub-combination thereof.

Similar to the plurality of outlet ports 74, the plurality of particle inlets 94 may be disposed uniformly or non-uniformly along the pair of side duct surfaces 82. For example, the plurality of particle inlets 94 may be spaced apart so as to have a greater airflow into the collection duct 76 at the plurality of particle inlets 94 individually (i.e., concentrating the plurality of particle inlets 94 at a location on the collection duct 76 may lessen the airflow into the collection duct 76 as a result of the vacuum pressure at that location). Likewise, the number of the plurality of particle inlets 94 can be limited to have a greater airflow into the collection duct 76 at the plurality of particle inlets 94. The plurality of particle inlets 94 may also be disposed on the collection duct 76 such that they are aligned with the plurality of outlet ports 74 to establish a more direct airflow into the collection duct 76 to better capture the ablated paint particles 45 (e.g., the alignment of the plurality of outlet ports 74 and the plurality of inlets 94 may a relatively stronger airflow into collection duct 76 to quickly capture suspended the ablated paint particles 45). Alternatively, the plurality of particle inlets 94 and the plurality of outlet ports 74 may not be aligned to establish a broader airflow from the plurality of outlet ports 74 into the plurality of particle inlets 94 (e.g., air being introduced from the plurality of outlet ports 74 will have a further path to flow before entering the plurality of particle inlets 94 such that a relatively wider range of the suspended ablated paint particles 45 may be drawn into the collection duct 76).

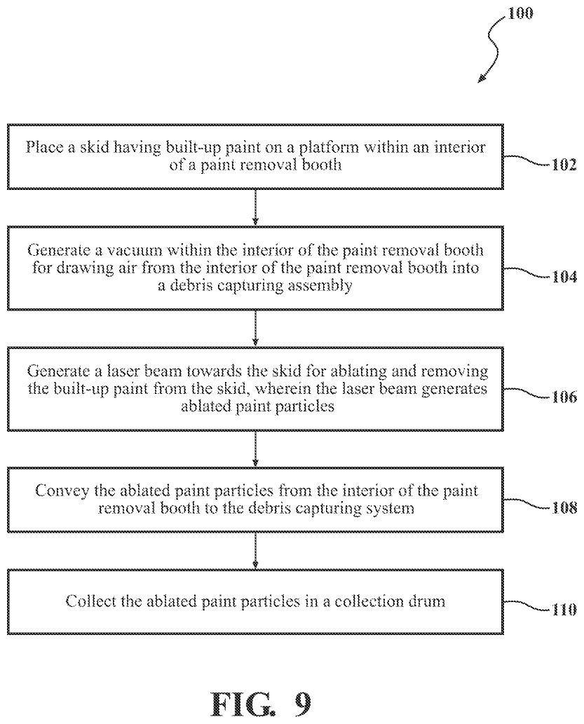

In operation, and as summarized in FIG. 9, a method 100 of removing paint build-up from the skid 30 begins at step 102 by placing the skid 30 having built-up paint overspray within the interior 26 of the paint removal booth 12 and on the platform 34. The arm 50 of the at least one laser ablation robot 46 moves to position the at least one laser ablation device 42 to target the surface of the skid 30. The retractable door 32 is closed to prevent workers from entering the paint removal booth 12, ablated paint particles 45 that will be generated from exiting the paint removal booth 12, and to restrict airflow exiting through the entry door 28, or the like. In certain embodiments, the entry door 28 is sealingly closed to prevent airflow from exiting through the entry door 28. The method 100 proceeds at step 104 by generating a vacuum within the interior 26 of the paint removal booth 12 for drawing air from the interior 26 of the paint removal booth 12 into the debris capturing assembly 14. In other words, the vacuum system is created by directing airflow within the interior 26 of paint removal booth 12 to the debris capturing assembly 14. The method 100 proceeds at step 106 by the at least one laser ablation device 42 generating and directing the laser beam 44 at the surface of the skid 30 to ablate the built-up paint from the skid 30, to generate ablated paint particles 45 within the interior 26 of the paint removal booth 12. The at least one laser ablation device 42 is re-positioned by articulation of the arm 50 throughout the process to target all surfaces of the skid 30 containing paint build-up. As the paint build-up is removed from the surface of the skid 30, the method proceeds at step 108 by drawing the ablated paint particles 45 into the collection duct 76 through the plurality of particle inlets 94 conveying the ablated paint particles 45 to the debris capturing assembly 14. The method 100 proceeds at step 110 by drawing the ablated paint particles 45 into the main body 62 to be filtered and collected in the collection drum 64 for collection. Once the control system 60 detects that the paint build-up has been sufficiently removed from the skid 30, the at least one laser ablation device 42 is deactivated and the retractable door 32 is opened to allow the skid 30 to be removed. The collection drum 64 is advantageously removed and transported away by the operator for efficient disposal of the ablated paint particles 45.

As discussed previously, this process advantageously produces a safe, efficient, and cost effective manner of removing paint from skids 30 that does not produce an extensive amount of wastewater as required in the prior art arrangements. For example, a prior art paint removal and wastewater system using high-pressure water tools could require about 8,760,000 US gallons of water annually, resulting in an annual water operating cost and wastewater treatment costs of about $30,000 dollars per year. The use of high-pressure water tools also requires an electrical usage of about 3,700,000 kW, which costs about $200,000 per year. Comparatively, the paint removal booth assembly described herein requires an estimated annual electrical usage of 535,000 kW and 0 gallons of water resulting in an approximated $200,000 in annual savings. In addition to water conservation, the laser ablation process also minimizes waste that results from traditional cleaning methods using chemicals. The ablated paint particles 45 can also be more easily disposed of in collection drum 64 rather than requiring a large quantity of wastewater that must be treated. Generating a smaller amount of waste allows a manufacture to more easily be compliant with regulation standards (e.g., regulation set by the Occupational Safety and Health Administration (“OSHA”) and/or the Environmental Protection Agency (“EPA”) and further reduces costs for the disposal of the waste. Finally, the laser ablation process also is safer as it requires no manual labor or human exposure to hazardous conditions while removing paint from the skid 30.

Obviously, many modifications and variations of the present invention are possible in light of the above teachings and may be practiced otherwise than as specifically described while within the scope of the appended claims.

What is claimed is:

1. A paint removal booth assembly comprising:
a paint removal booth defining an interior and including an entry door for allowing a skid having built-up paint overspray to enter the interior;
a platform disposed within the interior of the paint removal booth adjacent to the entry door for receiving the skid;
at least one laser ablation device disposed in the interior of the paint removal booth and configured to generate and direct a laser beam towards the skid for ablating the built-up paint overspray from the skid and generating ablated paint particles in the interior of the paint removal booth; and
a debris capturing assembly disposed in fluid communication with the interior of the paint removal booth and configured to draw the ablated paint particles from the interior of the paint removal booth and direct them to a collection drum disposed in an environment outside of the paint removal booth.

2. The paint removal booth assembly as set forth in claim 1, further comprising:
at least one laser ablation robot disposed in the interior of the paint removal booth adjacent to the platform; and
the at least one laser ablation device connected to the at least one laser ablation robot.

3. The paint removal booth assembly as set forth in claim 2 wherein the at least one laser ablation robot includes a plurality of laser ablation robots disposed in spaced relationship with one another adjacent the platform, and the at least one laser ablation device includes a plurality of laser ablation devices each connected to a respective one of the plurality of laser ablation robots.

4. The paint removal booth assembly as set forth in claim 1 further comprising a collection duct extending beneath the platform and disposed in fluid communication with the debris capturing assembly for capturing and conveying the ablated paint particles from the interior of the paint removal booth and towards the debris capturing assembly.

5. The paint removal booth assembly as set forth in claim 4, further comprising:
the paint removal booth including a floor extending from a front wall to a rear wall;
the collection duct extending along the floor from a first duct end disposed adjacent the front wall to a second duct end disposed adjacent the rear wall to define a pair of side duct surfaces extending in spaced and generally parallel relation with one another; and
the pair of side duct surfaces each defining a plurality of particle inlets disposed in spaced relationship with one another for allowing the ablated paint particles to enter the collection duct.

6. The paint removal booth assembly as set forth in claim 5, wherein the paint removal booth defines an exhaust port and a chute extends from the second duct end of the collection duct to the exhaust port for conveying the ablated paint particles from the collection duct and towards the debris capturing assembly.

7. The paint removal booth assembly as set forth in claim 6 further comprising a coupling duct extending from the exhaust port to the debris capturing assembly for establishing fluid communication therebetween.

8. The paint removal booth assembly as set forth in claim 7, wherein the debris capturing assembly includes a main body disposed above the collection drum and a motor is disposed between the coupling duct and the main body to generate a vacuum and draw the ablated paint particles from the interior of the paint removal booth into the main body through the coupling duct.

9. The paint removal booth assembly as set forth in claim 8, wherein the debris capturing assembly includes a hopper disposed beneath the main body for directing the ablated paint particles into the collection drum.

10. The paint removal booth assembly as set forth in claim 1, further comprising a conveyor disposed adjacent the entry door and in communication with the platform for transporting the skid from the environment outside of the paint removal booth, through the entry door and onto the platform disposed in the interior.

11. The paint removal booth assembly as set forth in claim 2 further comprising a control system disposed in communication with the at least one laser ablation robot for controlling a position of the at least one laser ablation robot and the at least one laser ablation device during the ablation of the built-up overspray.

12. A method of removing paint build-up from a skid comprising:
placing a skid having built-up paint on a platform within an interior of a paint removal booth;
generating a vacuum within the interior of the paint removal booth for drawing air from the interior of the paint removal booth into a debris capturing assembly;
generating and directing a laser beam towards the skid for ablating and removing the built-up paint from the skid in the form of ablated paint particles;
conveying the ablated paint particles from the interior of the paint removal booth to the debris capturing system; and
collecting the ablated paint particles in a collection drum.

13. The method as set forth in claim 12, wherein the conveying step includes drawing the ablated paint particles into a collection duct extending beneath the platform and disposed in fluid communication with the debris capturing assembly for capturing and conveying the ablated paint particles from the interior of the paint removal booth to the debris capturing assembly.

14. The method as set forth in claim 12, wherein the generating a laser beam step includes generating the laser beam from at least one laser ablation device arranged on the at least one laser ablation robot disposed in the interior of the paint removal booth.

15. The method as set forth in claim 12, wherein the conveying step includes capturing the ablated paint particles in a collection duct disposed beneath the platform and extending along a floor of the paint removal booth.
